(19) United States
(12) Patent Application Publication
(10) Pub. No.: US 2006/0126748 A1
(43) Pub. Date: Jun. 15, 2006

(54) Method for reducing peak-to-average power ratio of multi-carrier modulation

(76) Inventors: Mao-Chao Lin, Taipei City (TW); Shang-Kang Deng, Shulin City (TW)

Correspondence Address: LIN & ASSOCIATES INTELLECTUAL PROPERTY, P.O. BOX 2339, SARATOGA, CA, 95070-0339, US

(21) Appl. No.: 11/184,681

(22) Filed: Jul. 19, 2005

(30) Foreign Application Priority Data
Dec. 15, 2004 (TW) 93138992

(51) Int. Cl. H04K 1/10

(52) U.S. Cl. 375/260

(57) ABSTRACT

A method for reducing the peak-to-average power ratio of the time-domain signal in a communication system using multi-carrier modulation is provided herein. The present invention is based on the method of recursive clipping and filtering to reduce the peak-to-average power ratio and out-of-band spectrum, but during the recursive process, the distortion of the multi-carrier modulated signal is controlled to be bounded within a specific region. In an additive white Gaussian noise channel with high signal-to-noise ratio, the present invention could achieve significantly lower error rate and the error floor phenomenon is almost completely removed. Therefore the power amplifier could be operated at higher average output power and a smaller range of linearity.

### BACKGROUND OF THE INVENTION

1. Field of the Invention

The present invention generally relates to multi-carrier modulation, and more particularly to a method for reducing the peak-to-average power ratio of the multi-carrier modulated signal.

2. The Prior Arts

Multi-carrier modulation (MCM) technique has been widely applied in communication systems such as digital subscriber loop (DSL), digital video broadcasting (DVB), and wireless local area network (WLAN) etc., as it offers high spectral efficiency, high immunity to multi-path fading, easier equalization for frequency-selective fading channel (more details could be found in “Multicarrier modulation for data transmission: An idea whose time has come”, J. A. C. Bingham, IEEE Communication Magazine, Vol. 28, pp. 5-14, May 1990). A well known MCM technique is the orthogonal frequency division multiplexing (OFDM) technique. However, compared to communication systems using single-carrier modulation, an MCM system inherently has the problem of occasionally occurring high peak-to-average power ratio (PAPR), as its time-domain signal has an approximately Gaussian distribution resulted from the totaling effect of the many carriers (tones). Because of high PAPR, the transmitter of an MCM system has to be operated in the saturation mode from time to time so as to avoid the output power being too low. This saturation mode operation, however, inevitably causes nonlinear distortion and power spectral expansion (also known as out-of-band emission or out-of-band spectrum).

In recent years, quite a few methods have been proposed in the literature for reducing the PAPR of an MCM system. Among them, a group of methods sacrifice transmission rate in exchange for the reduction of PAPR. Some of these methods are as follows:

1) Selective mapping (SLM). The details of this method could be found in an article “Reducing the peak-to-average power ratio of multicarrier modulation by selected mapping,” R. W. Bauml, R. F. H. Fischer, and J. B. Huber, Electronic Letters, Vol. 32, pp. 2056-2057, October 1996;

2) Redundant coding. The details of this method could be found in “Block coding scheme for reduction of peak to mean envelope power ratio of multicarrier transmission scheme,” A. E. Jones, T. A. Wilkinson, and Barton, Electronic Letters, Vol. 30, pp. 2098-2099, December 1994, and in “Combined coding for error control and increased robustness to system nonlinearities in OFDM,” A. E. Jones and T. A. Wilkinson, IEEE Vehicular Technology Conference, Vol. 2, May 1996; and

3) Tone reservation. The details of this method could be found in chapter 4 of “Multi-carrier modulation with low PAR—Applications to DSL and wireless,” J. Tellado, Kluwer Academic Publishers, pp. 65-95, January 2000.

This group of methods doesn't seem to introduce distortion to the transmitted data at first glance. However, the insufficient PAPR reduction makes MCM systems unable to avoid the clipping distortion and out-of-band emission due to the nonlinearity of the power amplifier.

Another group of methods are derived from the clipping technique (more details can be found in “Envelope variations and spectral splatter in clipped multicarrier signal,” R. O'Neill and L. B. Lopes, IEEE PIMRC Conference, September 1995). Traditional clipping is imposed on the analog domain. A new clipping technique (please refer to “Performance analysis of deliberately clipped OFDM signals,” H. Ochiai and H. Imai, IEEE Transactions on Communications, Vol. 50, No. 1, January 2002, and “New OFDM peak-to-average power reduction scheme,” J. Armstrong, Proc. IEEE Vehicular Technology Conference, May 2001) is implemented in the digital domain by clipping the high peak of the oversampled signal and filtering out-of-band spectrum (referred to as oversampled clipping and filtering, OCF). A single OCF operation indeed could reduce PAPR and out-of-band spectrum to a certain degree. However, after the removal of the out-of-band spectrum, certain peak values above the clipping threshold would still occur, a phenomenon called peak power re-growth. To overcome the peak power re-growth problem, another method called recursive clipping and filtering (RCF) is proposed (please refer to “Peak-to-average power reduction for OFDM by repeated clipping and frequency domain filtering,” J. Armstrong, Electronics Letters, Vol. 38, No. 5). By increasing the number of recursions, RCF could effectively reduce PAPR and out-of-band spectrum. This comes however at the cost of severe clipping distortion and the accompanying phenomenon of error floor.

### SUMMARY OF THE INVENTION

As the foregoing methods to reduce PAPR in MCM systems, in practice, would all lead to signal distortion and power spectral expansion, or severe clipping distortion as the number of recursion increases, a novel method called RCFBD is therefore disclosed herein, which amends the RCF method with a bounded distortion control (BD control) so as to reduce the PAPR and out-of-band spectrum of the multi-carrier modulated signal and simultaneously control the clipping distortion and thereby, the data error rate.

One of the objectives of the present invention is to make use of the existing OCF method to reduce the PAPR and out-of-band spectrum, and then apply the BD control to the signal after OCF during the recursive process so as to limit the distortion of the data carried in the MCM communication system. In an additive white Gaussian noise (AWGN) channel, the present invention has roughly the same error rate as that of the RCF methods under low-to-medium signal-to-noise ratio (SNR). However, under high SNR, the present invention could achieve significantly lower error rate. Therefore, with the present invention, in an MCM system, a power amplifier with smaller range of linearity can be used or alternatively the power amplifier can be operated at smaller back-off, while the impact to error rate is under control. That means the linearity requirement for the power amplifier in the MCM communication systems using the present invention can be effectively reduced, which makes the present invention a key technology to achieve faster transmission rate and lower production cost.

Another objective of the present invention is that the algorithm and parameters for the BD control applied in the recursive process could be derived from the bounded distortion region (BD region), which limits the difference between the original data and the data after the BD control.

Yet another objective of the present invention is that, during the recursive process, the BD region, and the corresponding algorithm and parameters of each application of the BD control could be dynamically adjusted so as to strike a balance among error rate, PAPR, and out-of-band spectrum.

Still another objective of the present invention is that, during the recursive process, the clipping threshold could also be dynamically adjusted according to the BD region for each application of the BD control so as to strike a balance among error rate, PAPR, and out-of-band spectrum.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a transmitter of an MCM system.

FIG. 2 is a schematic diagram showing the various stages in an OCF process.

FIG. 3 is a schematic diagram showing a preferred embodiment of the present invention.

FIG. 4 is a schematic diagram showing the BD region for the tones of an OFDM system having 16-QAM signal constellation.

FIGS. 5-1 and 5-2 are graphs showing simulation results of the complementary cumulative distribution function (CCDF) of the peak power for the 128-tone/16-QAM OFDM systems using the RCF method and the RCFBD method of the present invention respectively.

FIGS. 6-1 and 6-2 are graphs showing simulation results of the power spectrum density (PSD) after the 3 dB power amplifier clipping for the 128-tone/16-QAM OFDM systems using the RCF method and the RCFBD method respectively.

FIGS. 7-1 and 7-2 are graphs showing simulation results of bit error rate (BER) after the 3 dB power amplifier clipping for the 128-tone/16-QAM OFDM systems using the RCF method and the RCFBD method in an AWGN channel respectively.

### DETAILED DESCRIPTION OF THE PREFERRED EMBODIMENTS

As explained earlier, the RCF method can effectively reduce PAPR and out-of-band spectrum in an MCM system. However, as the number of recursions increases, RCF could lead to severe clipping distortion and a phenomenon called error floor. The present invention, therefore, applies BD control to the baseband data after OCF during the RCF recursive process, so as to achieve lower error rate and simultaneously reduce PAPR and out-of-band spectrum. Compared to the original RCF method, the present invention not only preserves the benefit of RCF, but also achieves significantly lower error rate and removes the error floor phenomenon for an AWGN channel with high SNR. The method provided by the present invention is therefore referred as recursive clipping and filtering with bounded distortion (RCFBD) hereinafter.

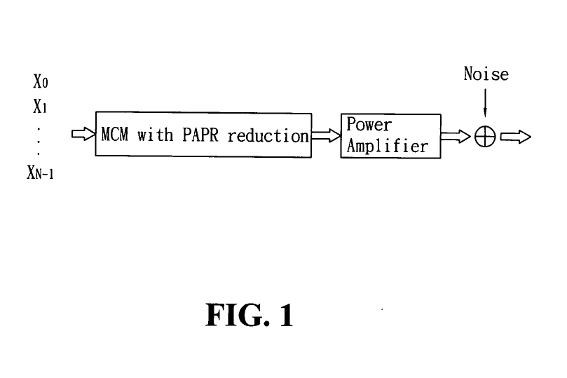

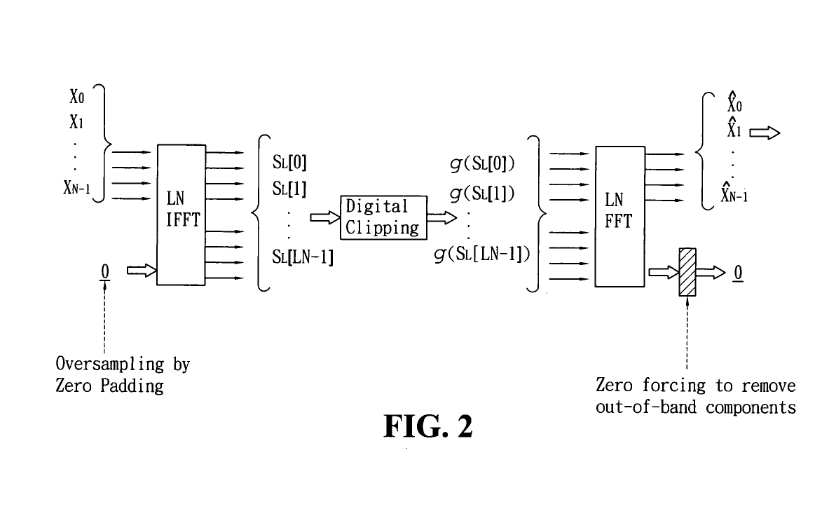

A preferred embodiment of the present invention is described as follows using a simplified MCM communication system as an example, whose transmitter is shown in FIG. 1. As illustrated, the baseband data X₀, X₁, . . . , X_{N-1} (N is number of tones) first go through MCM and PAPR reduction, and then into a power amplifier in a later stage. When digital clipping is used to reduce the PAPR, oversampling has to be performed prior to the digital clipping so that their PAPR are closer to the continuous-time signal, and, after the digital clipping, components in the out-of-band spectrum have to be filtered so as to avoid interfering with other communication systems. More details about this OCF process are illustrated in FIG. 2. As illustrated, oversampling with factor L is performed on the baseband data X₀, X₁, . . . , X_{N-1} by (L−1)N zero padding. Then an inverse fast Fourier transform (IFFT) is performed to obtain the interpolated (oversampled) discrete-time signal s_{L}(n), where n=0, 1, . . . , (LN−1), to approximate the continuous-time signal. Then digital clipping is performed to convert the input signal s_{L}(n) into g(s_{L}(n)), which is based on the following equations with ‘A’ representing the clipping threshold:
Input: x=ρ^{jφ},ρ=|x|
Output: g(x)=x, for ρ≦A
g(x)=Ae^{jφ}, for p>A

After s_{L}(n) are converted to g(s_{L}(n)) by digital clipping, g(s_{L}(n)) are then converted to frequency-domain signal via fast Fourier transform (FFT). The frequency-domain signal then have their out-of-band spectrum filtered to get the modified baseband data \hat{X}₀, \hat{X}₁, . . . , \hat{X}_{N-1}. The foregoing process of oversampling by zero-padding IFFT, clipping, and filtering out-of-band spectrum by FFT is the process of the OCF method.

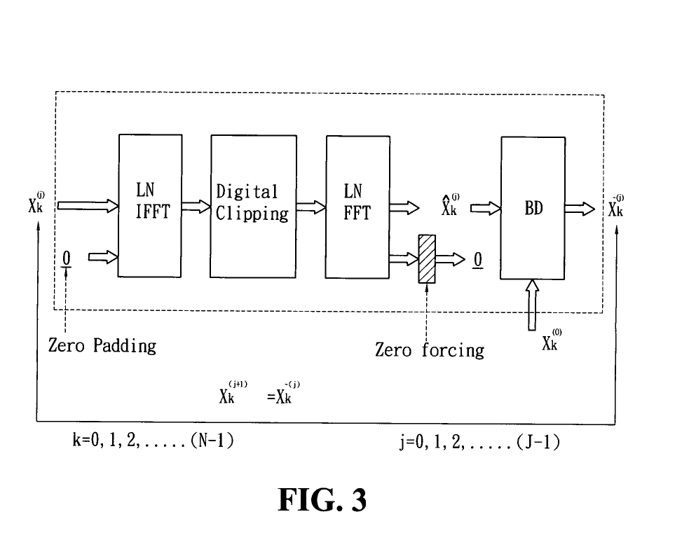

The RCFBD method of the present invention, as illustrated in FIG. 3, passes the baseband data through the OCF process recursively several times and, for each recursion, appropriately designed BD control and clipping threshold are applied so as to reduce the clipping distortion introduced by the conventional recursive OCF process (i.e. RCF). With the RCFBD method of the present invention, the clipping threshold and BD control could be dynamically adjusted for each recursion to achieve the required performance and characteristics of the MCM system. In FIG. 3, the total number of recursions is J, the superscript ‘j’ stands for the j-th recursion (j=0, 1, . . . , (J−1)) and the subscript ‘k’ stands for the k-th tone (k=0, 1, . . . , (N−1)).

As illustrated in FIG. 3, Xₖ⁽⁰⁾ stands for the original data carried by the k-th tone; \hat{X}ₖ^{(j)} stands for the data carried by the k-th tone after the jth recursion of OCF; \tilde{X}ₖ^{(j)} stands for the data carried by the k-th tone after the j-th recursion of OCF and BD control. In the following, for simplicity sake, the superscript ‘j’ is omitted.

The difference between \hat{X}ₖ and Xₖ⁽⁰⁾ is the clipping distortion before BD control. If the clipping distortion is too much, the receiver of the MCM system will not be able to detect the signal correctly, leading to degradation of error rate performance. The BD control applied by the present invention is about applying an appropriate processing to \hat{X}ₖ to yield \tilde{X}ₖ, so that the difference between the output of BD control, \tilde{X}ₖ, and the original reference, Xₖ⁽⁰⁾, would be within a specific region in order to bound the clipping distortion and simultaneously reduce the PAPR. This specific region is referred by the present invention as BD region. The BD region could be adjusted based on the characteristics of the MCM system. The BD region could also be varied for different tones, or dynamically adjusted during the recursive process. The adjustment of the BD region is based on the BD control algorithm and its parameters. For each recursion, the BD region, the BD control algorithm, and the parameters could all be dynamically adjusted. In addition, the clipping threshold for each recursion could also be adjusted in accordance with the BD region. As such, a balance among error rate, PAPR reduction, and out-of-band spectrum could be achieved.

For an OFDM system having 128 tones and 16-QAM signal constellation (128-tone/16-QAM OFDM system) with power amplifier operated under 3 dB clipping, the BD control algorithm is as follows:
Input: Xₖ⁽⁰⁾=(a₀, b₀) representing the original data carried on the k-th tone, a₀, b₀

$$∈ \{ \frac{1}{\sqrt{10}} , \frac{3}{\sqrt{10}} , \frac{- 1}{\sqrt{10}} , \frac{- 3}{\sqrt{10}} \} ;$$

\hat{X}ₖ=(a, b) representing the data carried on the k-th tone after OCF; δ representing the parameter which determines the BD region.

$$Δ x = ( a - {a}_{0} ) ; Δ y = ( b - {b}_{0} ) ; γ = \frac{2}{\sqrt{10}} ;$$

$$if ( \vert Δ x \vert \leq δ )$$

$${a}_{2} = a ;$$

$$else if ( ( {a}_{0} > 0 and a < {a}_{0} ) or ( {a}_{0} < 0 and a > {a}_{0} ) or ( \vert {a}_{0} \vert \leq γ ) )$$

$${a}_{2} = {a}_{0} + sign ( Δ x ) δ$$

$$else$$

$${a}_{2} = a ;$$

$$if ( \vert Δ y \vert \leq δ )$$

$${b}_{2} = b ;$$

$$else if ( ( {b}_{0} > 0 and b < {b}_{0} ) or ( {b}_{0} < 0 and b > {b}_{0} ) or ( \vert {b}_{0} \vert \leq γ ) )$$

$${b}_{2} = {b}_{0} + sign ( Δ y ) δ$$

$$else$$

$${b}_{2} = b ;$$
Output: \tilde{X}ₖ=(a₂, b₂) representing the output data carried on the k-th tone after BD control.

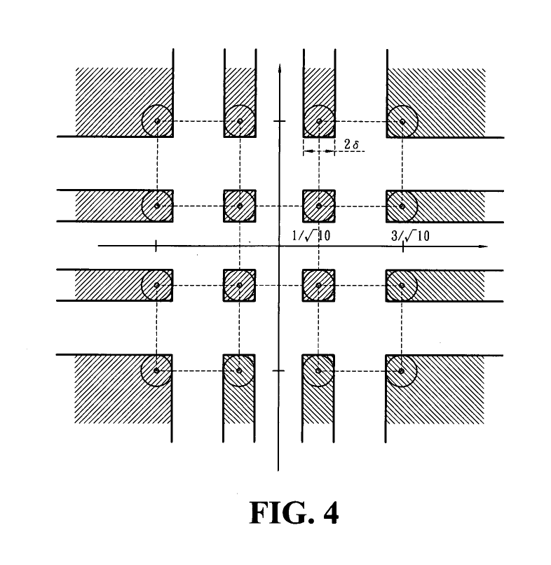

The BD region of the above algorithm for 16-QAM signal constellation is illustrated in the shaded regions of FIG. 4. The following equations could be used to adjust the BD parameter δ^{(j)} and clipping threshold A^{(j)} at the jth recursion (j=0, 1, . . . , J−1) with properly chosen A, A₀, η, β and ε:
δ^{(j)}=ηe^{(-βj)}, for 0≦j<└εJ┘
δ^{(j)}=δ, for └εJ┘≦j<J
A^{(j)}=A₀+(A−A₀)j/J, for 0≦j<J
In practice, the foregoing parameters used by the RFCBD method are as follows:

$$J = 8 , \\ A = 1.413 ( 3 dB ) , \\ {A}_{0} = 1.23 ( 1.8 dB ) , \\ η = 4.0 , \\ β = 0.38 , \\ ɛ = 0.75 , \\ δ = \frac{0.3}{\sqrt{10}} \sim \frac{0.8}{\sqrt{10}} .$$

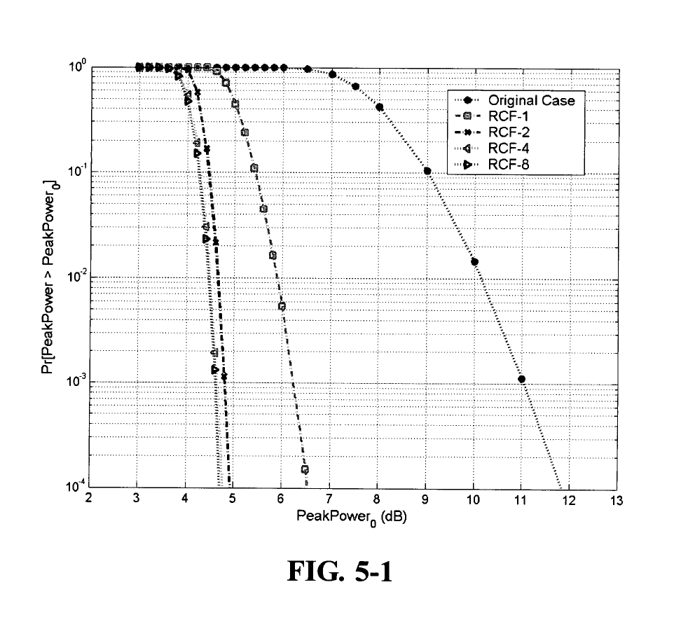

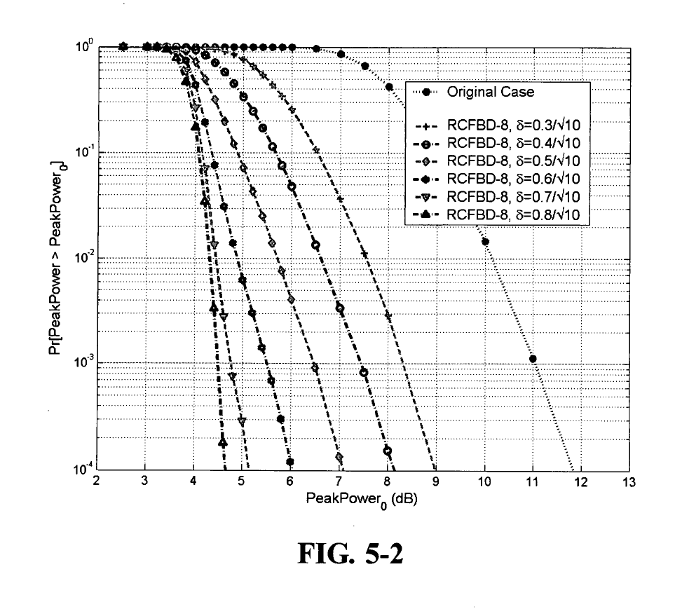

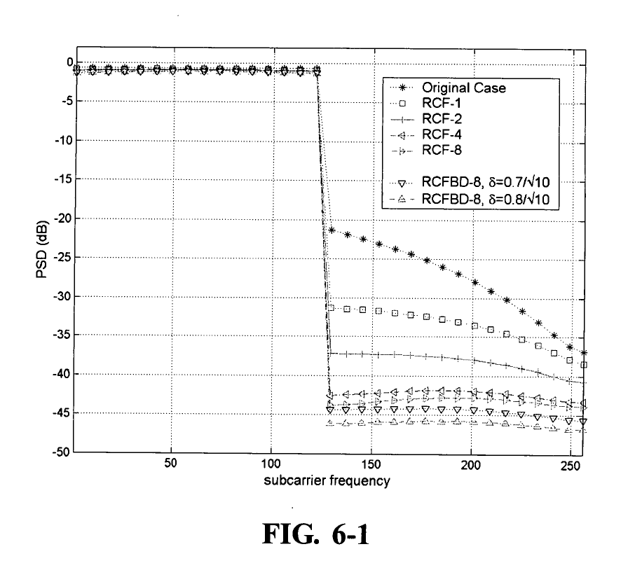

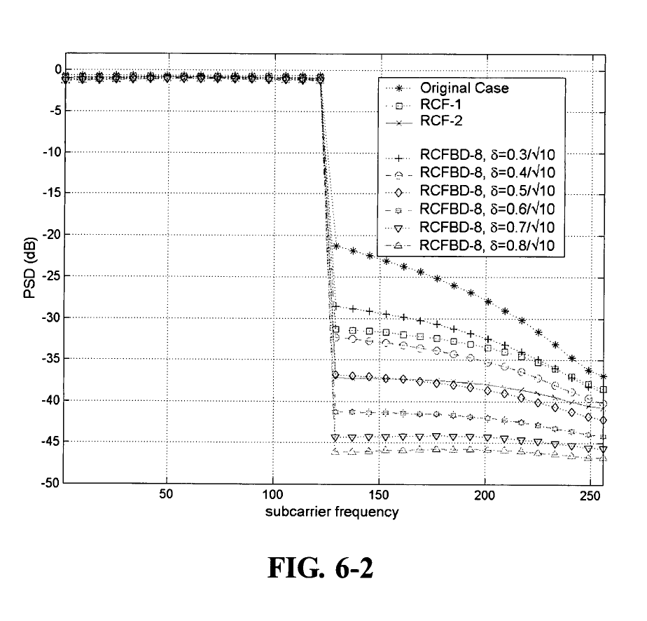

FIGS. 5-1 and 5-2 are graphs showing simulation results of the complementary cumulative distribution function (CCDF) of the peak power for the 128-tone/16-QAM OFDM systems using the RCF method and the RCFBD method of the present invention respectively, through which the PAPR reduction of the two methods could be compared. In the figures, RCF-J or RCFBD-J stands for the RCF or RCFBD method with recursions of J times. On the other hand, FIGS. 6-1 and 6-2 are graphs showing simulation results of the power spectrum density (PSD) after the 3 dB power amplifier clipping for the 128-tone/16-QAM OFDM systems using the RCF method and the RCFBD method respectively. In the figures, the original case refers to the situation that no PAPR reduction is performed before entering the power amplifier and, therefore, only the effect of power amplifier clipping is considered. As illustrated, the original case has the highest out-of-band spectrum followed by, in sequentially decreasing order,

$$RCFBD - 8 ( δ = \frac{0.3}{\sqrt{10}} ) , RCF - 1 , RCFBD - 8 ( δ = \frac{0.4}{\sqrt{10}} ) , RCF - 2 , RCFBD - 8 ( δ = \frac{0.5}{\sqrt{10}} ) , RCFBD - 8 ( δ = \frac{0.6}{\sqrt{10}} ) , RCF - 4 , RCF - 8 , RCFBD - 8 ( δ = \frac{0.7}{\sqrt{10}} ) , and RCFBD - 8 ( δ = \frac{0.8}{\sqrt{10}} ) , \\$$

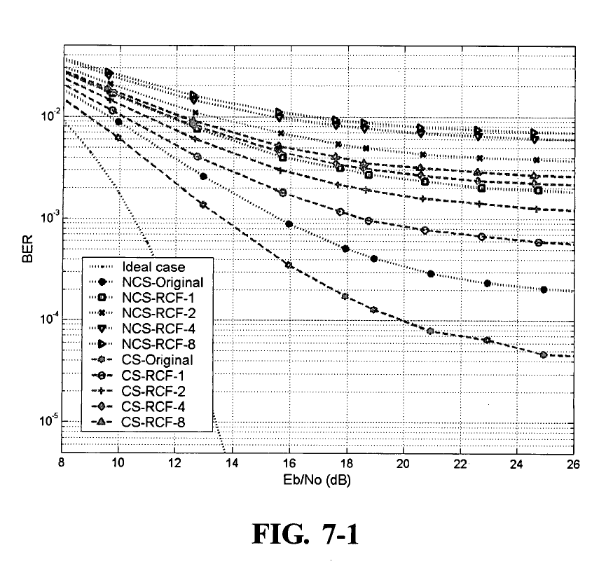

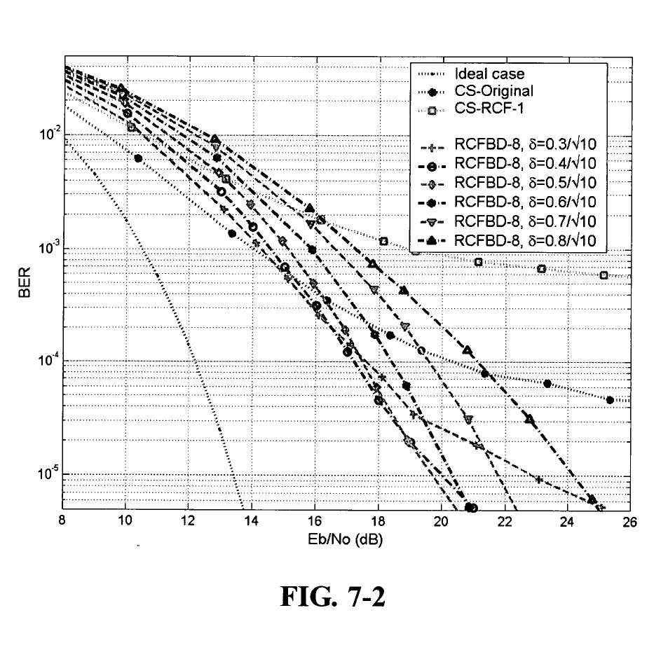

which has the lowest out-of-band spectrum. FIG. 7-1 is a graph showing simulation results of bit error rate (BER) of the RCF method in an AWGN channel under 3 dB power amplifier clipping. As illustrated, as the number of recursions increases, BER increases as well. Even for the original case, due to the effect of the power amplifier clipping, the error floor phenomenon still exists. Please note that, in FIG. 7-1, the “CS-” prefix stands for that constellation shrinkage information is utilized when the receiver performs detection while ‘NCS-’ prefix stands for that no such information is utilized (please refer to “A theoretical characterization of nonlinear distortion effects in OFDM systems,” Dardari, Tralli, and Vaccari, IEEE Transactions on Communications, Volume 48, Issue 10, October 2000, pp. 1755-1764). As illustrated, the use of the constellation shrinkage information indeed helps reducing BER but the error floor phenomenon remains. FIG. 7-2 is a graph showing simulation results of BER of the RCFBD method of the present invention in an AWGN channel without using constellation shrinkage information. Compared to FIG. 7-1, the RCFBD method of the present invention at high SNR is clearly advantageous in that not only the BER is lower, but also the error floor phenomenon is almost completely removed. In addition, when BER≦5×10⁻⁵,

$$RCFBD - 8 ( δ = \frac{0.4}{\sqrt{10}} , \frac{0.5}{\sqrt{10}} )$$

could provide a SNR gain 7 dB more than that of the original case, while the out-of-band spectrum is 12 dB lower than that of the original case. Please note that the ideal case in FIGS. 7-1 and 7-2 refers to the ideal situation that the power amplifier is an ideal one without any nonlinear clipping effect, henceforth no prior PAPR reduction is needed before entering the power amplifier. The ideal case is included in FIGS. 7-1 and 7-2 as a comparison reference.

In summary, the RCFBD method of the present invention, compared to the RCF method, could reduce PAPR and out-of-band spectrum more effectively. In an AWGN channel with high SNR, the present invention could achieve significantly lower BER. Therefore, in an MCM system with the present invention, the power amplifier with a smaller range of linearity can be used, or alternatively the power amplifier can be operated at a smaller back-off, while the error rate can remain low. The MCM communication system is therefore able to provide a higher transmission rate but with a lower production cost.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for reducing the peak-to-average power ratio in the transmitter of a multi-carrier modulation communication system, said method comprising at least the steps of:
applying an oversampled clipping and out-of-band spectrum filtering process recursively for a plurality of times to the baseband data of said communication system and, during each application of said process, applying a bounded distortion control so that clipping distortion will not degrade error rate performance.

2. The method according to claim 1, wherein said oversampled clipping and out-of-band spectrum filtering process comprises at least the steps of:
(a) applying oversampling to the baseband data;
(b) applying digital clipping to the result of said step (a); and
(c) filtering out-of-band spectrum from the result of said step (b).

3. The method according to claim 2, wherein said bounded distortion control is applied after said step (c).

4. The method according to claim 2, wherein said step (a) is performed on the baseband data by (L−1)N zero padding wherein N is the number of tones of said communication system and L is the oversampling factor, and then an inverse fast Fourier transform (IFFT) is performed to obtain the oversampled (interpolated) time-domain signal s_{L}(n) wherein n=0, 1, . . . , (LN−1), and said step (b) is performed to convert said time-domain signal s_{L}(n) into g(s_{L}(n)).

5. The method according to claim 4, wherein said conversion of signal s_{L}(n) to g(s_{L}(n)) is based on the following equation:
Input: x=ρ^{jφ}, ρ=|x|

Output: g(x)=x, for ρ≦A
g(x)=Ae^{jφ}, for ρ>A
wherein A is a clipping threshold, and said step (c) is performed by converting the digitally clipped signal g(s_{L}(n)) to frequency-domain signal via fast Fourier transform (FFT) and zero-forcing the out-of-band components.

6. The method according to claim 3, wherein said bounded distortion control is to process the baseband data after said step (c) so that the difference between the processed baseband data and the original baseband data falls within a specific bounded distortion region while said processed baseband data also has the reduced peak-to-average power ratio in time domain.

7. The method according to claim 6, wherein said bounded distortion region is varied for each recursion based on the parameters used in each recursion.

8. The method according to claim 6, wherein said bounded distortion region is varied based on the characteristics of said communication system.

9. The method according to claim 6, wherein said bounded distortion region is varied for each of said tones.

10. The method according to claim 5, wherein said clipping threshold is varied based on the characteristics of said communication system.

11. The method according to claim 9, wherein said bounded distortion region and said clipping threshold are varied based on the characteristics and performance requirements of said communication system.

12. The method according to claim 10, wherein said bounded distortion region and said clipping threshold are varied based on the characteristics and performance requirements of said communication system.
